(19) United States
(12) Patent Application Publication
(10) Pub. No.: US 2005/0287000 A1
(43) Pub. Date: Dec. 29, 2005

(54) Sealing apparatus for an electrical fan

(75) Inventors: Chin-Long Ku, Tu-Cheng (TW); Chin-Wen Yeh, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Foxconn Technology Co., Ltd., Tu-Cheng City (TW)

(21) Appl. No.: 11/135,573

(22) Filed: May 23, 2005

(30) Foreign Application Priority Data
Jun. 25, 2004 (CN) 200410027912.4

(51) Int. Cl. F16C 29/06

(52) U.S. Cl. 415/170.1

(57) ABSTRACT

A sealing apparatus for a fan includes a bearing support (20) and a sealing cover (10). The bearing support includes a base plate (22) with a tube (24) extending from a first side of the base plate. The tube receives a bearing and oil therein. A rotor rotatably engages with the bearing. The base plate defines a circular recess (224) in an opposite second side thereof communicating with an inner hole (242) of the tube, and mounting slots (222) each has a wide portion (222a) and a narrow portion (222b). The sealing cover includes a circular main plate (12) rotatably received in the recess of the bearing support, and latches (16) formed on the main plate and received in the mounting slots respectively. The latches are drivable to move between the narrow portions where the base plate clasps the latches and the wide portions where the base plate releases the latches.

### FIELD OF THE INVENTION

The present invention relates generally to an electrical fan, and more particularly to an oil sealing apparatus for a miniature electrical fan used in a computer for dissipating heat generated by electronic components of the computer.

### BACKGROUND OF THE INVENTION

A bearing is disposed around and supports a rotary shaft of an electrical fan so that the rotary shaft can rotate freely when the fan is activated. The bearing is mounted in a bearing support which is filled with oil so that the bearing can obtain sufficient lubrication during rotation. An oil sealing cover is provided to seal the bearing support to prevent the oil from leaking therefrom.

With reference to FIG. 5 and FIG. 6, a cross sectional view of an electrical fan 30 is shown. The fan 30 is a miniature fan for use in a computer to dissipate heat generated by high-power electronic components of the computer. The fan 30 includes a frame 31. A bearing support 32 is located at a middle portion of the frame 31. The bearing support 32 defines an inner hole 33 in a center thereof. A bearing 34 is secured in the hole 33 to rotatably support a rotor 35. An oil sealing cover 36 is mounted to a bottom end of the bearing support 32 to seal the hole 33. The cover 36 includes a circular plate 360, and a ring-like flange 361 axially and upwardly extending from a center of the plate 360. A plurality of bulges 362 radially extends from an outer surface of the flange 361. The flange 361 of the cover 36 is received in the hole 33, and the bulges 362 abut against an inner surface of the bearing support 32, so as to retain the cover 36 to the bearing support 32 and tightly seal the hole 33.

Since the cover 36 is retained to the bearing support 32 merely by the bulges 362 abutting against the bearing support 32, the cover 36 is easy to be pulled away from the bearing support 32 when the fan 30 is subject to a shock or vibration in operation. If this occurs, the oil will leak from the bottom of the bearing support 32.

What is needed, therefore, is an improved oil sealing apparatus for a heat dissipating fan used in an electronic device.

### SUMMARY OF THE INVENTION

According to a preferred embodiment of the present invention, a sealing apparatus for a heat dissipating fan includes a bearing support and a sealing cover. The bearing support is integrated to a frame of the fan and includes a base plate with a tube extending from a first side of the base plate. The base plate defines a circular recess in an opposite second side thereof communicating with an inner hole of the tube, and mounting slots each having a wide portion and a narrow portion. The inner hole is located at a center of the recess, and the mounting slots are located generally at a perimeter of the recess and equally spaced from each other. The sealing cover includes a circular main plate. To mount the sealing cover to the bearing support, the main plate of the sealing cover is received in the recess of the bearing support, and latches formed on the main plate are received in the wide portions of the mounting slots respectively. The latches are then driven by rotation of the main plate to move to the narrow portions where the base plate clasps the latches. The latches are drivable by rotation of the main plate to return to the wide portions where the base plate releases the latches.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a exploded isometric view of an oil sealing apparatus according to a preferred embodiment of the present invention;

FIG. 2 is similar to FIG. 1, but viewed from another aspect;

FIG. 3 is a partly assembled view of FIG. 1;

FIG. 4 is a fully assembled view of FIG. 1;

FIG. 5 is a cross sectional view of an electrical fan in accordance with prior art; and

FIG. 6 is a partly enlarged view of a portion of FIG. 5 indicated by reference number VI.

### DETAILED DESCRIPTION OF PREFERRED EMBODIMENT

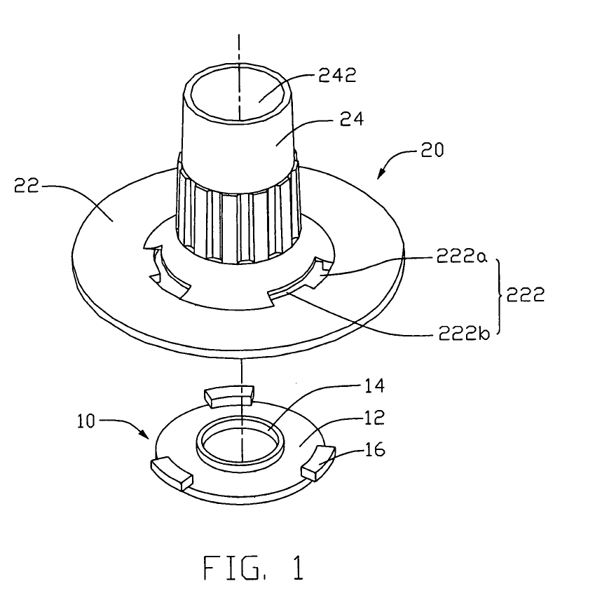

Referring to FIG. 1, a sealing apparatus for a heat dissipating fan includes a bearing support 20, and a sealing cover 10. The fan is a miniature electronic fan used in an electronic device to dissipate heat generated by high-power components thereof. The bearing support 20 is integrated with a frame (not shown) of the fan. A bearing (not shown) is mounted in the bearing support 20. A rotor shaft (not shown) is rotatably secured to the bearing so that when the fan is activated, the rotor shaft can rotate freely to drive a rotation of fan blades (not shown) connected with the rotor shaft whereby an air flow is generated.

The sealing cover 10 includes a circular main plate 12. A ring-like flange 14 extends upwardly from a top side of the main plate 12 around a center portion thereof. Three latches 16 are formed at a circumferential periphery of the main plate 12. Each latch 16 comprises a portion extending beyond the circumferential edge of the main plate 12.

The bearing support 20 is made of plastic or metal materials, and comprises a base plate 22, and a tube 24 perpendicularly extending from a centre of the base plate 22. The tube 24 defines an inner hole 242 therethrough corresponding to the flange 14 of the base plate 22. The inner hole 242 is for receiving the bearing therein. A diameter of an outer circumferential surface of the flange 14 is slightly greater than a diameter of the hole 242, so that the flange 14 can be interferentially fitted in the tube 24 to prevent lubricant oil received in the inner hole 242 from leakage.

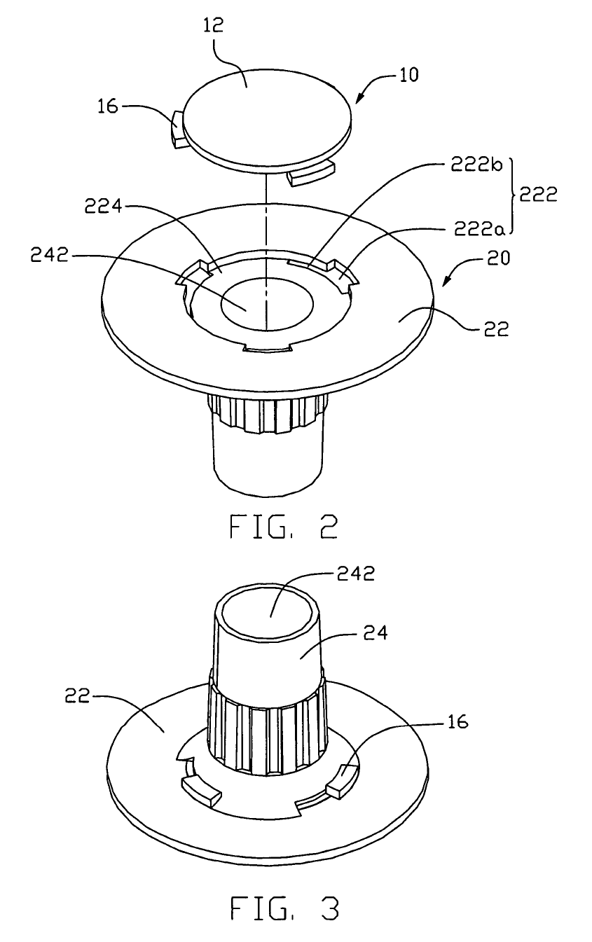

Referring also to FIG. 2, an underside of the base plate 22 defines a circular recess 224 therein for receiving the plate 12 of the cover 10. The recess 224 communicates with the inner hole 242 of the tube 24. The base plate 22 circumferentially defines three mounting slots 222 corresponding to the latches 16 of the cover 10. The mounting slots 222 communicate with the recess 224. Each of the mounting slots 222 has a wide portion 222a and a narrow portion 222b. A width of each wide portion 222a along a radial direction of the base plate 22 is greater than a width of each latch 16 along the radial direction of the main plate 12 of the cover 10, so that the latches 16 can easily enter the wide portions 222a respectively. A width of each narrow portion 222b along the radial direction of the base plate 22 is less than the width of each latch 16 along the radial direction of the main plate 12, so that when the latches 16 are disposed at the narrow portions 222b, the base plate 22 clasps the latches 16 in an axial direction of the inner hole 242 of the tube 24, and the bottom end of the inner hole 242 is closed by the cover 10.

Referring to FIG. 3, in assembly of the cover 10 to the bearing support 20, the main plate 12 of the cover 10 is received in the recess 224 of the bearing support 20, with the flange 14 received in the inner hole 242 of the tube 24 of the bearing support 20 and the latches 16 received in the wide portions 222a of the mounting slots 222 respectively.

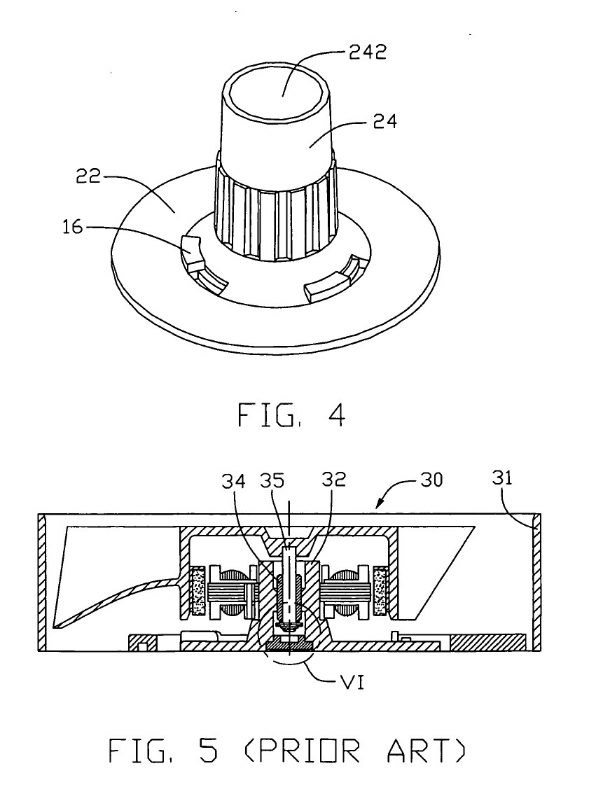

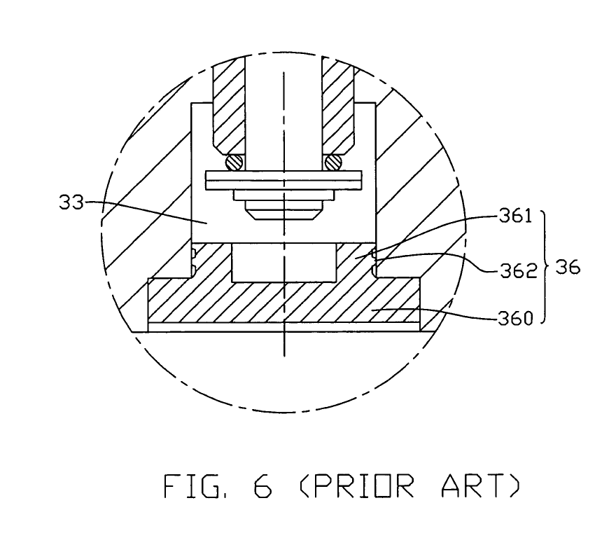

Referring to FIG. 4, the cover 10 is then rotated to drive the latches 16 to move in the mounting slots 222 from the wide portions 222a to the narrow portions 222b. As a result, the latches 16 are clasped by the base plate 22 at the narrow portions 222b of the mounting slots 222, preventing the cover 10 from axially moving away from the bearing support 20.

To remove the cover 10 from the bearing support 20, the cover 10 is simply rotated in a reverse direction, so that the latches 16 are driven to move back from the narrow portions 222b to the wide portions 222a to disengage from the mounting slots 222. Then the cover 10 is easily removed out.

In the present invention, the cover 10 is reliably retained to the bearing support 20 by the latches 16 engaging with the base plate 22 of the bearing support 20. Therefore, the cover 10 can hardly come off from the bearing support 20 undesignedly. In addition, because assembly and disassembly of the cover 10 to and from the bearing support 20 is accomplished by rotation of the cover 10, the use of the cover 10 is simplified.

In the preferred embodiment of the present invention, the latches 16 are formed at the circumferential periphery of the main plate 12, and the corresponding mounting slots 222 are circumferentially defined at the base plate 22 for receiving the latches 16 therein. Alternatively, the latches can also be formed at the base plate 22, and the mounting slots are defined at the main plate 12.

It is to be understood, however, that even though numerous characteristics and advantages of the present invention have been set forth in the foregoing description, together with details of the structure and function of the invention; the disclosure is illustrative only, and changes may be made in detail, especially in matters of shape, size, and arrangement of parts within the principles of the invention to the full extent indicated by the broad general meaning of the terms in which the appended claims are expressed.

1. A sealing apparatus for an electrical fan comprising:
a bearing support comprising a base plate with a tube extending from a first side of the base plate, the tube being for receiving a bearing and lubricant therein, the base plate defining a circular recess in an opposite second side thereof communicating with an inner hole of the tube, and mounting slots each having a wide portion and a narrow portion; and
a sealing cover comprising a circular main plate rotatably received in the recess of the bearing support, and latches formed on the main plate and received in the mounting slots respectively, the latches being drivable by rotation of the main plate to move between the narrow portions where the base plate clasps the latches and an end of the inner hole is closed by the sealing cover, and the wide portions where the base plate releases the latches.

2. The sealing apparatus as described in claim 1, wherein the sealing cover forms a ring-like flange extending upwardly from a center portion of the circular plate and engagingly received in the end of the inner hole of the tube.

3. The sealing apparatus as described in claim 2, wherein a diameter of an outer surface of the flange is slightly greater than a diameter of the hole.

4. The sealing apparatus as described in claim 1, wherein the latches are formed at a circumferential periphery of the main plate.

5. The sealing apparatus as described in claim 4, wherein a portion of each of the latches extends radially beyond the circumferential edge of the main plate.

6. The sealing apparatus as described in claim 1, wherein a width of each wide portion along a radial direction of the base plate is greater than a width of each latch along a radial direction of the main plate of the cover.

7. The sealing apparatus as described in claim 1, wherein a width of each narrow portion along a radial direction of the base plate is less than a width of each latch along a radial direction of the main plate.

8. An electrical fan comprising a frame, the frame comprising:
a tube located at a middle portion of the frame and having an end, the tube being adapted for receiving a bearing and lubricant therein;
a cover comprising a main plate enclosing said end of the tube;
a plurality of mounting slots defined in one of the frame and the cover, each mounting slots having a wide portion and a narrow portion communicating with each other; and
a plurality of latches formed at the other of the frame and the cover and extending into respective mounting slots to retain the cover to the frame, the cover sealing the end of the tube, the latches being sized such that, along a radial direction of the main plate, a width of the latches is less than a width of the wide portions but greater than a width of the narrow portions.

9. The electrical fan as described in claim 8, wherein the tube defines a circular recess at the end thereof for receiving the main plate.

10. The electrical fan as described in claim 8, wherein the main plate further comprises a flange extending upwardly from a top side and engagingly received in an inner hole of the tube at said end.

11. A method for sealing an opened end of a bearing support of an electrical fan, wherein the bearing support receives a bearing and oil therein, and defines a plurality of slots each having a wide and a narrow section, the method comprising:
bring a sealing cover to the opened end of the bearing support, the sealing cover having a plurality of latches each entering the wide section of a corresponding slot; and
rotating the sealing cover to a position wherein the latches are moved from the wide sections to the narrow sections of the slots, whereby the bearing support clasps the latches, and the opened end is closed by the sealing cover.

12. The method as claimed in claim 11, wherein the sealing cover has a ring-like flange which enters in the opened end of the bearing support when the sealing cover is brought to the opened end of the bearing support.

13. The method as claimed in claim 11, wherein the bearing support has a recess and the sealing cover is received in the recess when the sealing cover is brought to the opened end of the bearing support.
